(19) United States
(12) Patent Application Publication
(10) Pub. No.: US 2020/0135048 A1
(43) Pub. Date: Apr. 30, 2020

(54) KNOW-HOW PREPARING DEVICE, KNOW-HOW PREPARING METHOD, AND KNOW-HOW PREPARING PROGRAM

(71) Applicant: FANUC CORPORATION, Yamanashi (JP)

(72) Inventors: Masao KAMIGUCHI, Yamanashi (JP); Koji SAMUKAWA, Yamanashi (JP); Hiroji NISHI, Yamanashi (JP); Norinaga MUTAI, Yamanashi (JP)

(21) Appl. No.: 16/598,267

(22) Filed: Oct. 10, 2019

(30) Foreign Application Priority Data
Oct. 30, 2018 (JP) 2018-203650

(51) Int. Cl. G09B 19/00; G09B 5/02

(52) U.S. Cl. CPC G09B 19/003; G09B 5/02

(57) ABSTRACT

An edge server includes a storage unit that stores event data prepared by associating events relating to a value of any of items or a combination of the items included in time series data collected from equipment with associated data of each of the events including identification information of an operator; an extraction section that extracts the event data that are linked with an operator included in a predetermined period during an operating time of the equipment for each of the operators; a preparation section that prepares feature data relating to an operation procedure and a work time for each of the operators on a basis of the even data extracted for each of the operators; and an output section that outputs the feature data.

This application is based on and claims the benefit of priority from Japanese Patent Application No. 2018-203650, filed on 30 Oct. 2018, the content of which is incorporated herein by reference.

### BACKGROUND OF THE INVENTION

### Field of the Invention

The present invention relates to a device, a method, and a program for accumulating know-how information relating to operating states of equipment.

### Related Art

Conventionally, in industrial sites such as factories, the activity for trying to improve the production efficiency of a factory overall has progressed by visualizing the operating states of various pieces of equipment such as machine tools and peripheral devices. Furthermore, in Japanese Unexamined Patent Application, Publication No. 2014-209307, a plant operation system is proposed which handles various types of events occurring in a plant on the basis of know-how of experts. In this system, the action records of experts which were prepared by hand are used.

Patent Document 1: Japanese Unexamined Patent Application, Publication No. 2014-209307

### SUMMARY OF THE INVENTION

Information relating to, for example, an operating state of equipment as described above and the action of experts is included in data acquired from various pieces of equipment in an industrial site, and visualization can be expected by properly organizing these pieces of data.

However, methods of acquiring various types of data from various pieces of equipment are not unified in many cases. In particular, it is normal in an industrial site for equipment installed several decades ago and the latest equipment to coexist together. Given this, for example, even if the latest equipment has an advanced function that transmits data only when a specific event occurs, the old equipment simply transmits data at a predetermined cycle. Therefore, data formats provided from each piece of the equipment vary. For this reason, it is difficult to specify the required data from among acquired large time-series data and properly organize required information, and the analyses by operators also vary greatly.

The present invention has an object of providing a know-how preparing device, a know-how preparing method, and a know-how preparing program that can accumulate know-how information relating to operating states of equipment when a specific event occurs in the equipment.

According to the first aspect of the present invention, a know-how preparing device (for example, the edge server 1 described later) includes: a storage unit (for example, the storage unit 20 described later) configured to store event data (for example, the event data 22 described later) prepared by associating events relating to a value of any one or a combination of items included in time series data (for example, the time series data 21 described later) collected from equipment (for example, the equipment 2 described later) with associated data of each of the events including identification information of an operator; an extraction section (for example, the extraction section 15 described later) configured to extract the event data that are linked with an operator included in a predetermined period during an operating time of the equipment for each of the operators; a preparation section (for example, the preparation section 16 described later) configured to prepare feature data relating to an operation procedure and a work time for each of the operators on a basis of the even data extracted for each of the operators; and an output section (for example, the output section 17 described later) configured to output the feature data.

According to the second aspect of the present invention, in the know-how preparing device as described in the first aspect, the extraction section may extract, related to each of a plurality of types of stages included in an operating time of the equipment (2), respective event data (22) included in a period of each of a plurality of stages, and the preparation section may prepare the feature data for each of the stages and for each of the operators.

According to the third aspect of the present invention, in the know-how preparing device as described in the second aspect, the extraction section may determine a start and an end of a stage among the stages on a condition of a specific event among the events occurring.

According to the fourth aspect of the present invention, in the know-how preparing device as described in any one of the first to third aspects, the output section may output the feature data by ranking the feature data on a basis of proficiency information assigned in advance to the operators.

According to the fifth aspect of the present invention, in the know-how preparing device as described in any one of the first to fourth aspects, the output section may output the feature data to be ranked on a basis of proficiency information assigned in advance to the operators.

According to the sixth aspect of the present invention, a know-how preparing method executed by a computer (for example, the edge server 1 described later) includes the steps of: extracting, from among event data (for example, the event data 22 described above) prepared by associating events relating to a value of any one or a combination of items included in time series data (for example, the time series data 21 described later) collected from equipment (for example, the equipment 2 described later) with associated data of each of the events including identification information of an operator, the event data that are linked with an operator included in a predetermined period during an operating time of the equipment for each of the operators; and preparing feature data relating to an operation procedure and a work time for each of the operators on a basis of the event data extracted for each of the operators; and outputting the feature data.

According to the seventh aspect of the present invention, a know-how preparing program according to the present invention is a program that causes a computer to function as the know-how preparing device (1) as described in any one of the first to fifth aspects.

According to the present invention, it is possible to accumulate know-how information relating to operating states of equipment when a specific event occurs in the equipment.

### BRIEF DESCRIPTION OF THE DRAWINGS

FIG. 1 is a diagram illustrating a functional configuration of an edge server according to an embodiment;

FIG. 2 is a table exemplifying time-series data according to an embodiment;

FIG. 3 is a table exemplifying a storing rule according to an embodiment;

FIG. 4 is a table exemplifying event data according to an embodiment;

FIG. 5 is a flowchart exemplifying a method of preparing event data according to an embodiment;

FIG. 6 is a diagram illustrating a screen display example by a playback section according to an embodiment;

FIG. 7 is a diagram exemplifying a relationship between stages and events according to an embodiment;

FIG. 8 a flowchart exemplifying a method of preparing know-how information according to an embodiment; and

FIG. 9 is a diagram illustrating a functional configuration of a debugging device according to an embodiment.

### DETAILED DESCRIPTION OF THE INVENTION

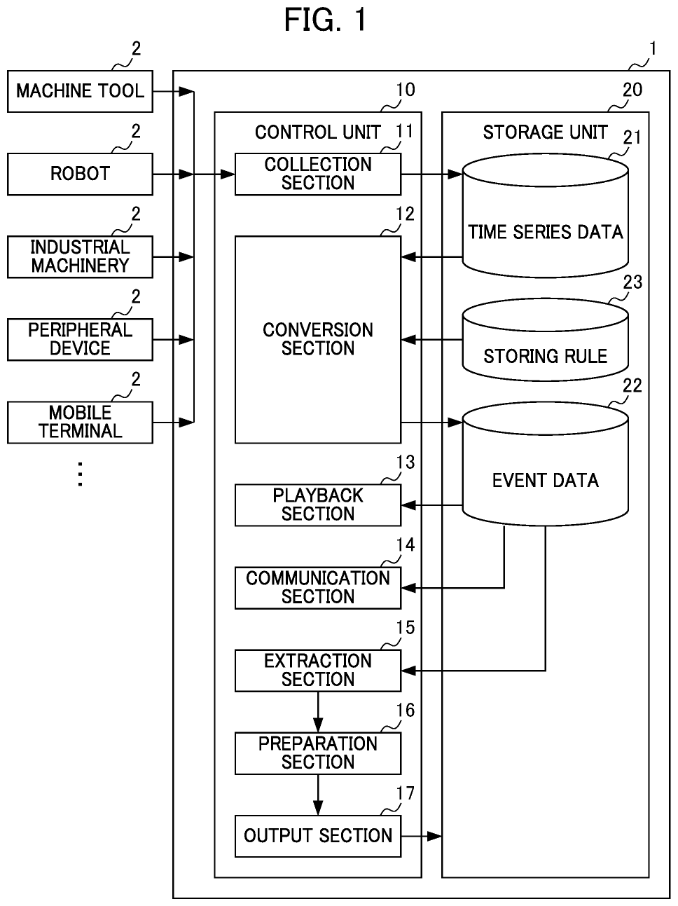

In the following, an example of an embodiment of the present invention will be described. FIG. 1 is a diagram illustrating the functional configuration of an edge server 1 (data preparing device, know-how preparing device) according to the present embodiment. The edge server 1 is an information processing device that is connected with various pieces of equipment 2 used in a factory and in communication with them. The equipment 2 includes industrial machinery such as a machine tool, a robot or an injection molding machine, a peripheral device such as a delivery vehicle or a conveyor, and a mobile terminal such as a tablet terminal or mobile phone on which an operator performs input. The edge server 1 includes an interface that communicates with each piece of equipment 2. Furthermore, for example, a sensor, a camera, or the like that monitors a person's action may be connected, as the equipment 2, to the edge server 1.

The edge server 1 includes a control unit 10 and a storage unit 20, and further includes various types of input/output devices and a communication interface. The control unit 10 executes predetermined software (data preparing programs and know-how preparing programs) stored in the storage unit 20, thereby realizing each function of the present embodiment. The control unit 10 includes, as functional units relating to the preparation and use of event data 22 described later, a collection section 11, a conversion section 12, a playback section 13 (a display section), and a communication section 14 and, as functional units relating to the preparation and use of know-how information, an extraction section 15, a preparation section 16, and an output section 17.

Furthermore, the storage unit 20 stores time series data 21, event data 22, and a storing rule 23, in addition to the data preparing programs. Moreover, the storage unit 20 stores various types of application programs that perform analysis using the time series data 21 and the event data 22, and are executed by the control unit 10. Results from the execution of these application programs may be outputted to a display device of the edge server 1 or may be transmitted in response to access from a client terminal.

First, provided are descriptions relating to the collection section 11, the conversion section 12, the playback section 13, and the communication section 14 as the functional units relating to the preparation and use of the event data 22.

The collection section 11 collects, together with time information, data that is observed at or inputted by each piece of the equipment 2, and stores them as the time series data 21 in the storage unit 20. The time series data 21 may be acquired by polling from each piece of the equipment 2 at a constant cycle, or may be acquired at individual cycles. Alternatively, data may be transmitted from the equipment 2 aperiodically according to the occurrence of a specific event.

It should be noted that the collection section 11 collects the time series data 21 via an interface having a function of converting electric signals, a communication protocol, data format, etc., between the edge server 1 and the equipment 2. Furthermore, in a case in which the equipment 2 is based on unified standards such as Ethernet, etc., the collection section 11 can collect the time series data 21 in a predetermined data format by software. The communication interface is not limited to a wired connection, and for example, the edge server 1 may be connected to the equipment 2 via a wireless LAN.

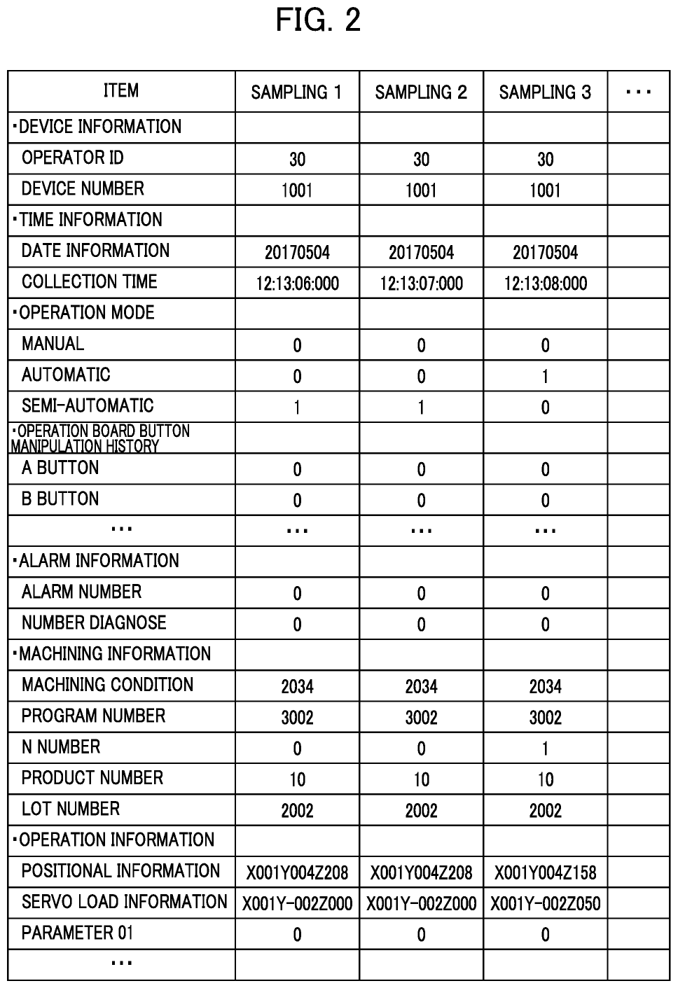

FIG. 2 is a diagram exemplifying the time series data 21 according to the present embodiment. The time series data 21 differ depending on the types of the equipment 2. For example, as illustrated in FIG. 2, values of a plurality of items are acquired for each predetermined sampling cycle, and recorded sequentially. In this example, an operator ID and a device number, which are pieces of key information, and various types of values are stored in a 1-second cycle.

The conversion section 12 extracts, for each event, associated data of the event from the time series data 21 in accordance with the storing rule 23 that is defined in advance, and converts the resulting data into the event data 22.

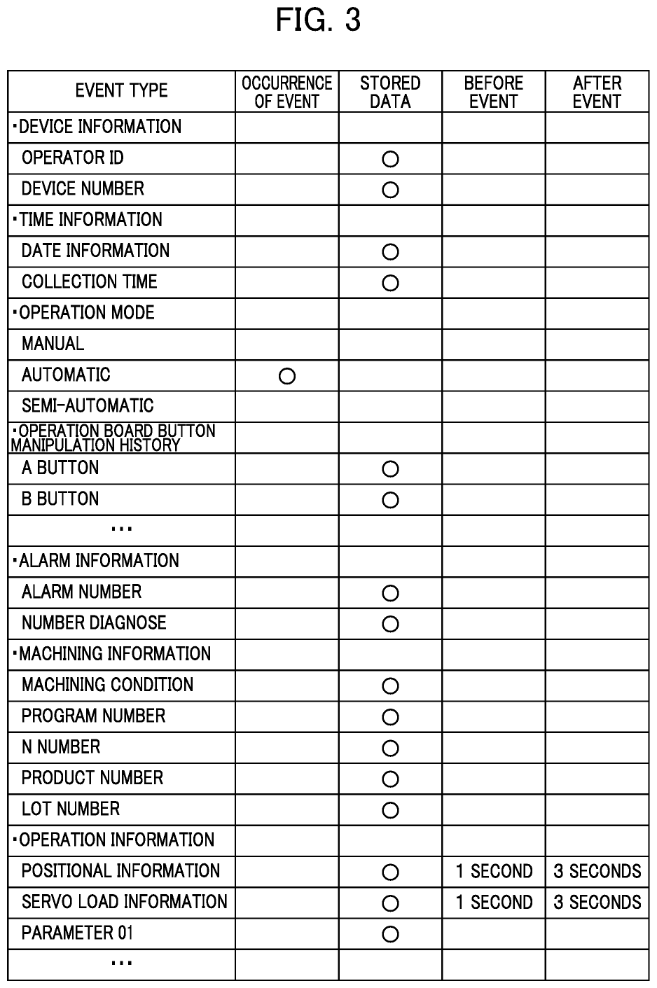

FIG. 3 is a diagram exemplifying the storing rule 23 according to the present embodiment. With a case of any of the items or a combination of the items included in the time series data 21 becoming a predetermined value as an event, the storing rule 23 defines, for each of the events, an item of the associated data as a storing target. Furthermore, the storing rule 23 defines, for each of the events, a period for extracting each piece of associated data.

In this example, a case of the operating mode being switched to automatic, i.e., a case of an automatic operation starting, is set as an event, and storing various kinds of data, which are associated data, including operation board button manipulation history, alarm information, machining information, and operation information, together with device information and time information are designated. Furthermore, for position information and servo load information, data of a period 1 second before and 3 seconds after an occurrence of an event are stored. Naturally, for example, a combination of the situation in which the operation mode is switched to automatic and the automatic operation starts and a situation in which an A button of the operation board is pressed, may be set as an event, and storing various types of data together with device information and time information may be designated.

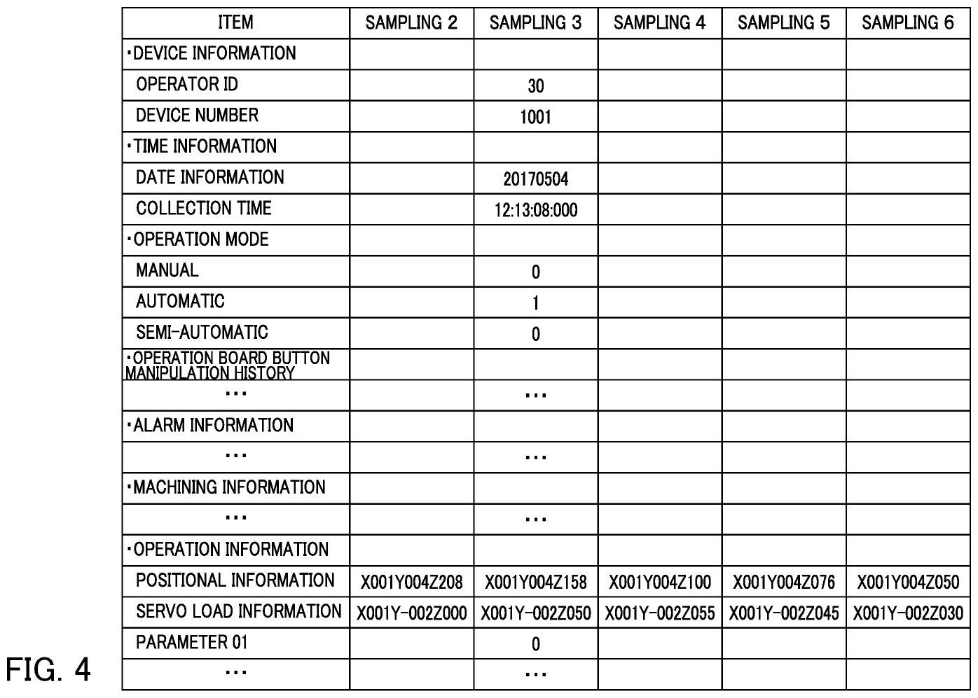

FIG. 4 is a diagram exemplifying the event data 22 according to the present embodiment. The conversion section 12 uses, for example, the storing rule 23 of FIG. 3 to detect, as an event, a situation in which the operation mode is switched from semi-automatic to automatic in “Sampling 3” in the time series data of FIG. 2. Then, the conversion section 12 extracts associated data included in “Sampling 3” in accordance with the storing rule 23. At this time, with regards to the position information and the servo load information, data of a period from “Sampling 2” which is 1 second before “Sampling 3” until “Sampling 6” which is 3 seconds after “Sampling 3” are extracted.

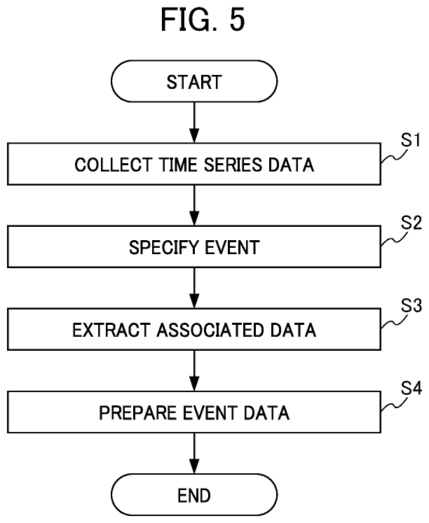

FIG. 5 is a flowchart exemplifying a method of preparing the event data 22 according to the present embodiment. In Step S1, the collection section 11 collects the time series data 21 at a predetermined cycle, from each piece of the equipment 2, and accumulates them in the storage unit 20.

In Step S2, the conversion section 12 specifies an event from among the time series data 21 in accordance with the storing rule 23. In Step S3, the conversion section 12 extracts associated data of the specified event over a predetermined period in accordance with the storing rule 23. In Step S4, the conversion section 12 associates the associated data extracted for each event with an event to prepare the event data 22, and stores them in the storage unit 20.

It should be noted that the processing of the conversion section 12 preparing the event data 22 from the time series data 21 in Steps S2 to S4 may be executed periodically or at a designated timing.

The playback section 13 extracts, from the event data 22, events that occur in a predetermined period in a designated piece of the equipment 2, and synchronizes data values for each of the events in a time series manner to display them.

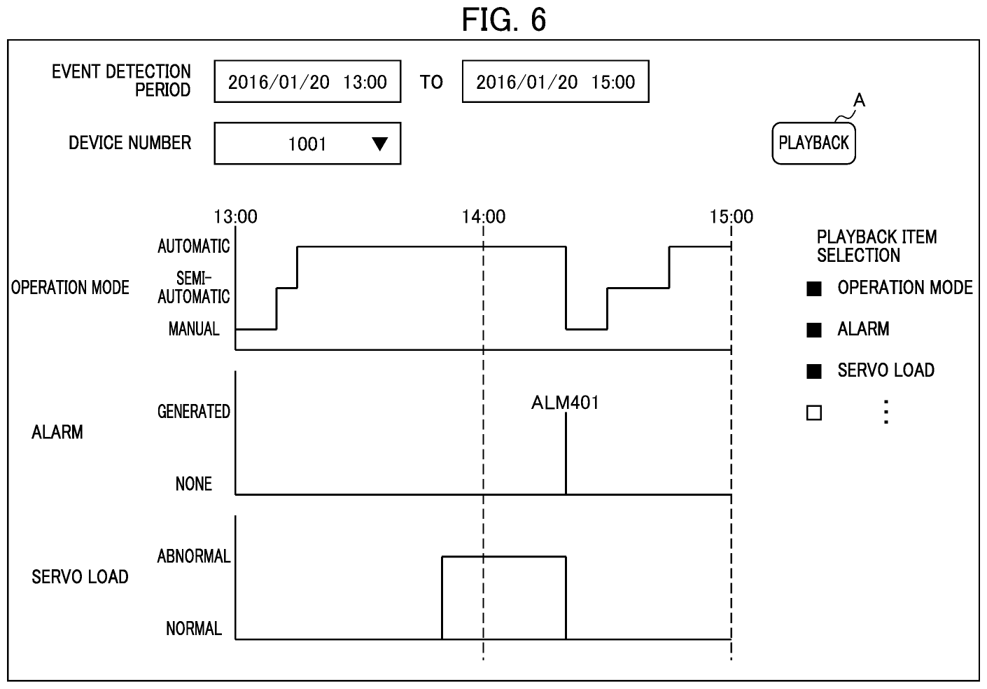

FIG. 6 is a diagram illustrating a screen display example by the playback section 13 according to the present embodiment. In this example, as an event detection period, 2016/01/20 13:00 to 2016/01/20 15:00 is designated. Furthermore, a device number 1001 with which the equipment 2 is identified is designated. By a playback button A being pressed, the playback section 13 extracts an event that occurs in a designated period in the designated equipment 2, and displays, on a graph, data values for each item for which the event occurs. At this time, the time axis of each graph is identical, and the values of each item are displayed in a synchronized manner.

In this example, it is recognized that the operation mode is switched from manual to automatic via semiautomatic past 1 o'clock PM, and the servo load starts to exhibit an abnormal value before 2 o'clock PM, and thereafter, the operation mode is switched to manual in response to the occurrence of an alarm. It should be noted that, with respect to the servo load, the case in which, for example, the load exceeds 50% is set as an event (abnormal) from the point of view of prevention and maintenance, and the servo load is expressed by two values of normal and abnormal. Furthermore, the items of display target such as the operating mode, the alarm, and the servo load may be selectable.

The communication section 14 transmits the accumulated time series data 21 or the event data 22 to the outside in response to a request. For example, the communication section 14 can provide test data to a debugging environment described later. Furthermore, the communication section 14 may inquire, to the outside, information associated with the event data 22 such as a problem accompanied with the event and a handling method of the problem, and associate information received therefrom with the event data 22, and store the resulting information in the storage unit 20.

With the functional units described above, the edge server 1 prepares the event data 22 from the time series data 21 and makes an operating state of the equipment 2 visible to provide a user with the visible operating state. Next, the extraction section 15, the preparation section 16, and the output section 17, which are functional units relating to the preparation and use of know-how information, will be described.

The extraction section 15 extracts the event data 22 that are linked with operators included in a predetermined period during an operating time of the equipment 2, for each operator. At this time, the extraction section 15 extracts the event data 22 included in a period of each of a plurality of stages included in the operating time of the equipment 2.

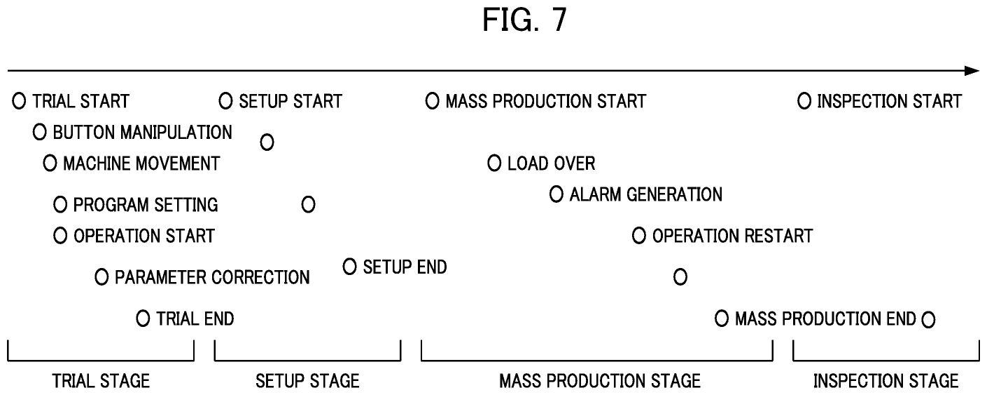

FIG. 7 is a diagram exemplifying the relationship between stages and events according to the present embodiment. Examples of the stages include a trial manufacture stage, a setup stage, a mass production stage, an inspection stage, etc. The extraction section 15 may determine the start and end of these stages on the condition that a specific event occurs. For example, the start and the end of the automatic operation (the start of manual or semi-automatic operation) are recognized as the start and the end of the mass production stage. Alternatively, for example, an input operation of the start and end of the setup may be detected as an event.

The preparation section 16 prepares feature data relating to an operation procedure and work time for each operator with the equipment 2 on the basis of the event data 22 extracted for each operator. At this time, the preparation section 16 prepares the feature data for each stage and for each operator, and stores the resulting data in the storage unit 20. With such a configuration, the features of operation that vary depending on the operators when an event occurs are accumulated as know-how information.

The feature data includes, for example, information relating to various kinds of operation procedures such as software operation, keyboard input, and button manipulation of an operation board, and information relating to changes of the state and the parameter of the equipment 2, etc., before and after these operations. Furthermore, image data, moving image data, or an account of handling contents that is separately recorded by an operator upon handling an event may be added as the feature data.

The output section 17 outputs the feature data that is prepared by the preparation section 16 and stored in the storage unit 20 to a display device or an external device as the know-how information. The output section 17 may output the feature data by ranking them on the basis of proficiency information assigned in advance to the operators. With such a configuration, it is possible to easily refer to the operation procedure of an operator having high proficiency. It should be noted that, for example, proficiency is evaluated on the basis of years of experience or past training history. Furthermore, the output section 17 may output the feature data by ranking them on the basis of work time. With such a configuration, it is possible to easily refer to an efficient operation procedure with short work time.

When a new event occurs, the operator can retrieve, from the event data 22, a previous event that is identical or similar to the new event on the basis of the device number or model number of the equipment 2, the kind of an event, machining information or operation information before and after the occurrence of the event, etc. The feature data of the operator at the time when a retrieved event occurred are outputted by the output section 17 in the order of higher proficiency, shorter work time, or the like, and becomes know-how information for assisting in handling new events. At this time, a display mode which can compare the feature data of the operator having higher proficiency with the feature data of the operator having lower proficiency may be employed. Alternatively, a display mode which can compare the feature data of the operator having shorter work time with the feature data of the operator having longer working hours may be employed.

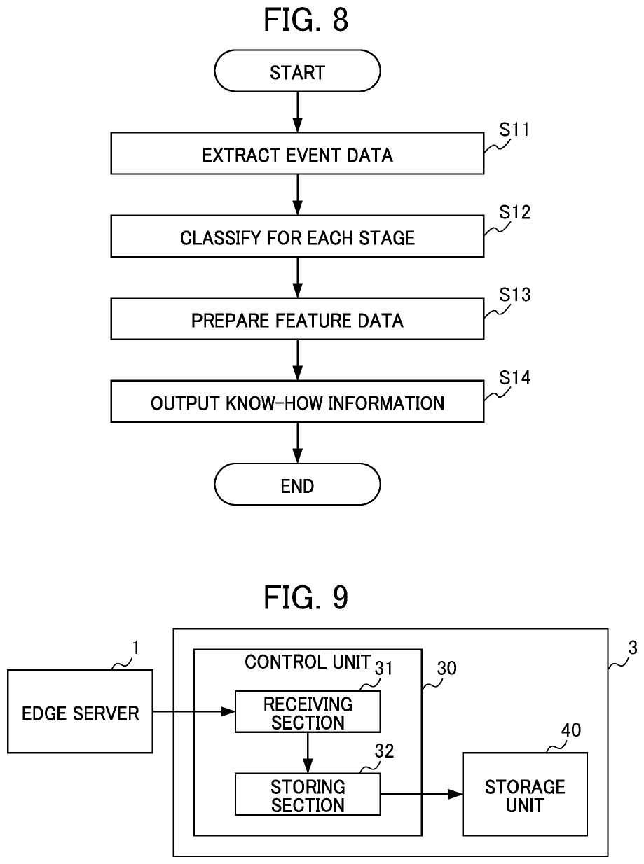

FIG. 8 is a flowchart exemplifying a method of preparing know-how information according to the present embodiment. In Step S11, the extraction section 15 extracts the event data 22 from the storage unit 20 for each operator. In Step S12, the extraction section 15 determines the start and end of each of the plurality of stages, and classifies the event data 22 for each stage.

In Step S13, the preparation section 16 prepares the feature data for each stage and for each operator on the basis of the event data 22, and stores the resulting data in the storage unit 20. In Step S14, the output section 17 ranks and shapes the feature data on the basis of the proficiency, work time, or the like of the operator, and outputs the resulting data as know-how information.

Here, a specific example of the know-how information for each stage will be described.

### (Trial Manufacture Stage)

In the trial manufacture stage, important purposes are being able to perform machining that falls within tolerance of design and creating a program and a machining condition that enable stable machining upon mass production.

For example, in a case of cutting, the CNC program is prepared by CAM or manually, and trial cutting is performed. The operator pursues a condition that achieves at least the above-described purpose by, for example, selecting auxiliary equipment for machining such as a tool, coolant, and a jig, and modifying the degree of acceleration and deceleration upon operating the CNC program and the cutting path.

Furthermore, in a case of plastic machining, for example, plastic molding, when pouring plastic into a mold for new machining, a molding processor temporarily sets a similar condition based on shapes and materials that are previously processed, and adjusts conditions sequentially.

As described above, in the cutting, a program and modified contents of the program (modification of acceleration, deceleration, speed, a machining path, and the like), selection of a tool, selection of a jig, selection of auxiliary equipment, and the like become knowledge (know-how information) in the trial manufacture stage. Furthermore, in the plastic machining, selection of resins, change of conditions, the order of the processes, and the like become knowledge in the trial manufacture stage.

### (Setup Stage)

In the setup stage, setup hours can be aggregated for each operator and each product, and the setup hours are extracted as the feature data. Furthermore, in the setup stage, various manipulation buttons are used. Therefore, the feature data can be extracted on the basis of the use frequency of the buttons, as follows. Here, a machining center having an X-axis, Y-axis, Z-axis, and spindle is described as an example.

In the setup stage, there are operations such as (1) mounting a workpiece, (2) preparing a tool, (3) adjusting the tool length, (4) adjusting of coolant, and (5) confirming a program. In (1) mounting a workpiece, an operator moves the table along the X axis and the Y axis, stops the table at the position where the workpiece can be fixed, and mounts and fixes the workpiece to the table. From this operation, it is possible to acquire information relating to a movement time, a movement distance, a movement override, and the like of the table along the X axis and the Y axis, and by organizing these pieces of information, it is possible to extract the feature data as to how to move the table upon mounting a workpiece.

In (2) preparing a tool, an operator causes a turret to rotate, and if a tool is placed in a tool magazine, extracts the tool, and mounts the required tool. Since a tool confirmation switch is provided in the tool magazine, whether a tool is being attached or detached is determined. Therefore, the feature data of the attached time or the detached time for each tool can be extracted on the basis of, for example, a tool number.

As for (3), there are some methods for adjusting the tool length; however, a machine in which a contact sensor that measures the length of a tool is attached to the table to which the workpiece is attached is generally used. With such a machine, an operator causes a tool that is newly attached thereto to be brought into contact with this contact sensor. The coordinates of the Z axis direction (height direction) when in contact with the sensor are decided depending on the kind of tool. In a case in which the height when a tool is actually attached and is brought into contact with the sensor differs from the height that is set in advance, the operator manually or automatically re-sets a parameter of the control device by using the difference as a tool length correction value. From this operation, it is possible to acquire information such as a movement time, a movement distance, and a movement override of the Z axis, and by organizing these pieces of information, it is possible to extract the feature data as to how to move the Z axis upon mounting a workpiece. Furthermore, it is also possible to extract the feature data as to how to move in the height direction on the basis of the number of times going up and down along the Z axis.

As for (4), coolant has a function of cooling a machined portion to prevent the temperature of the portion from becoming high during machining and a function of flowing cut chips generated during cutting to prevent the cut chips from interfering in the machining. A coolant liquid is supplied in a machine with a flexible hose for supply. The operator makes an adjustment by manually pouring the coolant liquid while the operator changes its angle. From this operation, it is possible to extract the feature data of the coolant adjustment such as the number of times ON/OFF of the coolant liquid, the flow rate setting of the coolant liquid, etc.

As for (5), confirming a program is an operation that selects a necessary program from a directory on a screen. An operator confirms whether a selected program is proper or not through a program confirmation screen or idle machining. As a history of the manipulation button, how to call a program, how to check a program, etc. are stored. Therefore, it is possible to extract the feature of a calling procedure, the feature of a checking method, etc. from this history.

Furthermore, the time of the entire setup stage is also significant feature data and, if the setup time is long, it is possible to further extract the feature data from the axis transfer time and the number of times of axis transfer in each of the abovementioned operations. It should be noted that the switching time of each of the operations is made clear by showing the procedure of each of the operations as a guidance of the setup stage on a tablet terminal, for example, and allowing an operator to input the start and end of the operations.

### (Mass Production Stage)

The start of the mass production stage is determined by a start event of automatic operation, and the end of the mass production is determined by an end event of a main program. Furthermore, the timing of the start and end of the mass production can be determined by setting, as an event, the time when an operator inputs from a tablet terminal and the like. In general, an operator is not involved with operation during automatic operation. However, in a case in which the automatic operation is stopped due to the following factors, the operator performs a recovery operation and continues the mass production. The main factors that stop the automatic operation include, for example, a disconnection alarm of a signal line that controls an interface with a peripheral device, failure alarm of a switch that confirms that a safety door is closed, and insufficient cooling or clogging of cut chips due to an insufficient flow rate of cutting liquid.

Examples relating to cutting liquid will be described. The insufficient flow rate of cutting liquid may be caused by the adjustment performed in the setup stage of, for example, the flow rate of coolant and the position of a hose. For example, if the flow rate or the direction of flow of the cutting liquid exceeds an appropriate range, cut chips are accumulated in the interior of a machine, which causes clogging at a cover that protects a ball screw for driving. Due to this clogging, the cover that moves together with the ball screw hardly moves, and phenomena occur such as load resistance of a motor that drives the ball screw increasing. Furthermore, if the cooling efficiency drops due to the insufficient flow rate of the cutting liquid, the tool edge of a drill as a tool and a workpiece (for example, a casting to be machined) becomes hot, which causes progress of wear of the tool or machining defect.

These phenomena appear as abnormal load on the spindle that rotates a tool or abnormal load on the servo motor of each of the X, Y, and Z axes that stop the tool through positioning control. The abnormal load on the servo motor due to these mechanical factors is notified to an operator as an alarm relating to the servo by a control system in order to ultimately protect the servo motor. For example, in the example of FIG. 6 as described above, an event relating to abnormality in load of the servo during the mass production occurs, the alarm is generated and the machine is ultimately stopped.

The event of abnormality in load of the servo is recorded, for example, by defining a situation in which the load to the motor of each of the axes becomes no less than 50% as abnormality in load. With such a method, it is possible to grasp at which position the abnormality in load occurred and what kind of load abnormality occurred during cutting. By comparing this data with data of the same machining in the past, it is possible to find the difference in how the cutting liquid is applied due to the difference in adjustment method of the cutting liquid between the operators.

Furthermore, in the example of FIG. 6, excessive load alarm is ultimately generated. By analyzing a subsequent event relating to the manipulation buttons, it is possible to find the difference in an alarm recovery procedure due to the difference of the operating method between operators. In this way, individual differences of the operators are extracted from the event data 22 for each of the various events in each stage, and thus accumulated.

### (Inspection Stage)

In the inspection stage, there are some factors that cause an inspection defect. One of them is, for example, a problem caused during setup of inspection, and may be a case in which a workpiece to be inspected was not prepared correctly in an inspection device, or may be a case in which the procedure of an inspection method was wrong. With regards to these factors, it is possible to extract the feature data by analyzing, for example, the number of manipulations and the order of manipulations of the manipulation buttons provided to the inspection device, actual measurement values, and the number of the measurements being restarted, for each of the operators.

Furthermore, in a case in which a machining defect actually occurs, it is possible to analyze issues upon the setup relating to machining by analyzing a setup history of an operator who performed the setup. Furthermore, it is also possible to use information relating to a position at which a machining defect occurred as a basis for determining whether a machining program was optimal for the machined shape.

The functions relating to the preparation and use of the know-how information by the edge server 1 are described as above. Next, a device for performing a test for application programs using data accumulated in the edge server 1 and debugging will be described.

As described above, the edge server 1 of the present embodiment can execute various kinds of application programs by using the time series data 21, the event data 22, and the accumulated know-how information, and can provide users with results from the execution. Such application programs may be modified for the purpose of adding or improving a function, in addition to fixing a malfunction. In the present embodiment, a debugging device 3 having a test environment of a modified application is provided, for example, as a cloud server.

FIG. 9 is a diagram illustrating a functional configuration of the debugging device 3 according to the present embodiment. The debugging device 3 is an information processing device that can communicate with the edge server 1, includes a control unit 30 and a storage unit 40, and further includes various types of input/output devices and a communication interface. The control unit 30 executes predetermined software stored in the storage unit 40, thereby realizing each function of the present embodiment. More specifically, the control unit 30 includes a receiving section 31 and a storing section 32 as functional units that are realized by software.

The receiving section 31 receives the time series data 21 and the event data 22 used by the application programs from the edge server 1.

The storing section 32 stores the data that have been received, in a reference area of the application programs in the test environment in the storage unit 40. This configuration allows for the operation of the test and debugging by using the same data as that of an actual environment of the edge server 1.

According to the present embodiment, in a case where a situation in which any of the items or a combination of the items included in the time series data 21 collected from the equipment 2 becomes a predetermined value is set as an event, the edge server 1 stores a storing rule 23 that defines associated data as a storing target for each of the events. The edge server 1 extracts the associated data for each event from the time series data 21 in accordance with the storing rule 23, and converts resultant data into the event data 22. Therefore, since the edge server 1 prepares the event data 22 that only consists of associated data of an event in accordance with a rule that is defined in advance, information in which an operating state when a specific event occurs in the equipment 2 is organized can be accumulated. As a result of this, the event data 22 with constant quality is automatically prepared even in a case in which the old equipment 2 from which only cyclic data is obtained is included in a factory.

Since the edge server 1 defines a data extraction period before and after the occurrence of an event for each item as a storing rule 23, the information relating to the event such as the factor of the occurrence of the event, the state change after the occurrence of the event, and the procedure for handling the event can be accumulated appropriately as the event data 22.

Since the edge server 1 synchronizes the events that occur in a predetermined period in a time series manner to display them, the operator can easily grasp the history of the occurrence of a plurality of kinds of events.

Furthermore, the debugging device 3 includes the test environment of the application programs that operate with the edge server 1. The debugging device 3 receives the event data 22 from the edge server 1 and stores them in the test environment, thereby making it possible to perform the operation of the test using actual data and debugging without affecting the edge server 1 in operation.

The edge server 1 extracts event data included in a predetermined period, and prepares the feature data relating to an operation procedure and work time for each of the operators. Therefore, the edge server 1 can accumulate the feature of the operation contents at the time of the occurrence of an event for each of the operators as the know-how information relating to the operating state when a specific event occurs in the equipment 2.

Since the edge server 1 prepares the feature data for each stage and for each operator, for each of a plurality of kinds of stages, more detailed know-how information specific to each stage can be accumulated. Since the edge server 1 determines the start and end of each stage on the condition that a specific event occurs, the separation of the stages is automated, which improves convenience.

Since the edge server 1 ranks the feature data on the basis of the proficiency information assigned to the operators, it is possible to provide useful know-how information such as the operation procedure of an expert using the proficiency as an index. Since the edge server 1 ranks the feature data on the basis of work time, it is possible to provide useful know-how information such as an efficient operation procedure using the work time as an index.

Although an embodiment of the present invention has been described above, the present invention is not limited thereto. Furthermore, the effects described in the present embodiment are merely listed as the most preferred effects produced from the present invention, and the effects according to the present invention are not limited to those described in the present embodiment.

In the present embodiment, the edge server 1 converts the time series data 21 into the event data 22. However, the data acquired from the equipment 2 that outputs the data in response to the occurrence of the event may be stored directly as the event data 22. In such a case, if necessary, the conversion section 12 extracts previous data from the time series data 21 and associates with the event data 22, thereby storing resultant data.

In the present embodiment, the event is mainly described as an event that is defined for a single item. However, the present invention is not limited thereto. For example, the event may be determined in combination with a plurality of items. In such a case, a determination condition of the event such as a comparison of each of item values or an AND condition is described in the storing rule 23.

In the present embodiment, the edge server 1 is configured to prepare the event data 22 and the know-how information. However, the present invention is not limited thereto. For example, the extraction section 15, the preparation section 16, and the output section 17 that prepare the know-how information may be arranged in another information processing device that is connected to the edge server 1 and in communication with the edge server 1.

The data preparation method and the know-how preparation method by the edge server 1 are realized by software. In the case of being realized by software, programs that constitute the software are installed in a computer. Furthermore, these programs may be recorded in removable media and distributed to users, or alternatively may be downloaded and distributed to a user's computer via a network.

### EXPLANATION OF REFERENCE NUMERALS

1 edge server
3 debugging device
10 control unit
11 collection section
12 conversion section
13 playback section
14 communication section
15 extraction section
16 preparation section
17 output section
20 storage unit
21 time series data
22 event data
23 storing rule
30 control unit
31 receiving section
32 storing section
40 storage unit

What is claimed is:

1. A know-how preparing device comprising:
a storage unit configured to store event data prepared by associating events relating to a value of any one or a combination of items included in time series data collected from equipment with associated data of each of the events including identification information of an operator;
an extraction section configured to extract the event data that are linked with an operator included in a predetermined period during an operating time of the equipment for each of the operators;
a preparation section configured to prepare feature data relating to an operation procedure and a work time for each of the operators on a basis of the event data extracted for each of the operators; and
an output section configured to output the feature data.

2. The know-how preparing device according to claim 1, wherein
the extraction section extracts, related to each of a plurality of types of stages included in an operating time of the equipment, respective event data included in a period of each of a plurality of stages, and
the preparation section prepares the feature data for each of the stages and for each of the operators.

3. The know-how preparing device according to claim 2, wherein the extraction section determines a start and an end of a stage among the stages on a condition of a specific event among the events occurring.

4. The know-how preparing device according to claim 1, wherein the output section outputs the feature data to be ranked on a basis of proficiency information assigned in advance to the operators.

5. The know-how preparing device according to claim 1, wherein the output section outputs the feature data to be ranked on a basis of the work time.

6. A know-how preparing method executed by a computer, the method comprising the steps of:
extracting, from among event data prepared by associating events relating to a value of any one or a combination of items included in time series data collected from equipment with associated data of each of the events including identification information of an operator, the event data that are linked with an operator included in a predetermined period during an operating time of the equipment for each of the operators;
preparing feature data relating to an operation procedure and a work time for each of the operators on a basis of the event data extracted for each of the operators; and
outputting the feature data.

7. A non-transitory computer-readable medium encoded with a know-how preparing program that causes a computer to function as the know-how preparing device according to claim 1.
